(19) United States
(12) Patent Application Publication
(10) Pub. No.: US 2016/0217108 A1
(43) Pub. Date: Jul. 28, 2016

(54) BIFURCATED PRESENTATION OF E-CONTENT ON AN E-READING DEVICE

(71) Applicant: Kobo Incorporated, Toronto (CA)

(72) Inventors: Nora PARKER, Toronto (CA); Benjamin LANDAU, Toronto (CA)

(73) Assignee: KOBO INCORPORATED, Toronto (CA)

(21) Appl. No.: 14/603,855

(22) Filed: Jan. 23, 2015

(51) Int. Cl. G06F 17/22; G06F 3/0483

(52) U.S. Cl. CPC G06F 17/2247; G06F 3/0483

(57) ABSTRACT

A system and method for bifurcated presentation of e-content on an e-reading device is disclosed. One embodiment includes a primary display of an e-reading device for presenting a page of an e-book thereon. In addition, a secondary display is also coupled with the e-reading device for presenting a portion of the page of the e-book thereon, wherein the primary display and the secondary display are not concurrently visible from a same plane of view.

### TECHNICAL FIELD

Examples described herein relate to a system and method for bifurcated presentation of e-content on an e-reading device.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal display devices are among numerous kinds of consumer devices that can receive services and utilize resources across a network service. Such devices can operate applications or provide other functionality that links a device to a particular account of a specific service. For example, the e-reading devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates an e-reading device configured with dual displays for bifurcated presentation of e-content on an e-reading device, in an embodiment.

FIG. 2 illustrates a schematic architecture of an e-reading device configured with dual displays for bifurcated presentation of e-content on an e-reading device, according to an embodiment.

FIG. 3A illustrates a block diagram of a primary display and a secondary display on an e-reading device, according to an embodiment.

FIG. 3B illustrates a block diagram of a primary display and a secondary display on an e-reading device, according to an embodiment.

FIG. 4 illustrates a method for bifurcated presentation of e-content on an e-reading device, according to an embodiment.

### DETAILED DESCRIPTION

Methods and systems for bifurcated presentation of e-content on an e-reading device are disclosed. In one embodiment, an e-Reader device is equipped with both front & rear facing displays, one of the displays being a very-low power-usage display, in addition to the regular primary display. In one embodiment, a bifurcated or extracted portion of e-book page content is presented on the secondary display, which the presenter reads from, while full content is delivered via the primary LCD display to the audience. Whether presenting to coworkers, reading to children, or lecturing on a subject that requires visuals referents, the feature enables readers to show their audience the primary display, while still following along to a visually simplified version of the matching text on the secondary rear surface display.

For example, when reading a storybook to one or more children the reader must continuously turn the page back and forth between their audience and themselves in order to read the words. This not only makes it difficult to read, but each time the presenter turns the display for viewing, their audience's view and experience of the content is interrupted. The technology described herein ensures that a display will be simultaneously available for both the audience and the presenter, thereby resulting in a smooth, easy to follow presentation.

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-reading devices”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reading device, such as a purpose-built device that is optimized for an e-reading experience (e.g., with e-Ink displays).

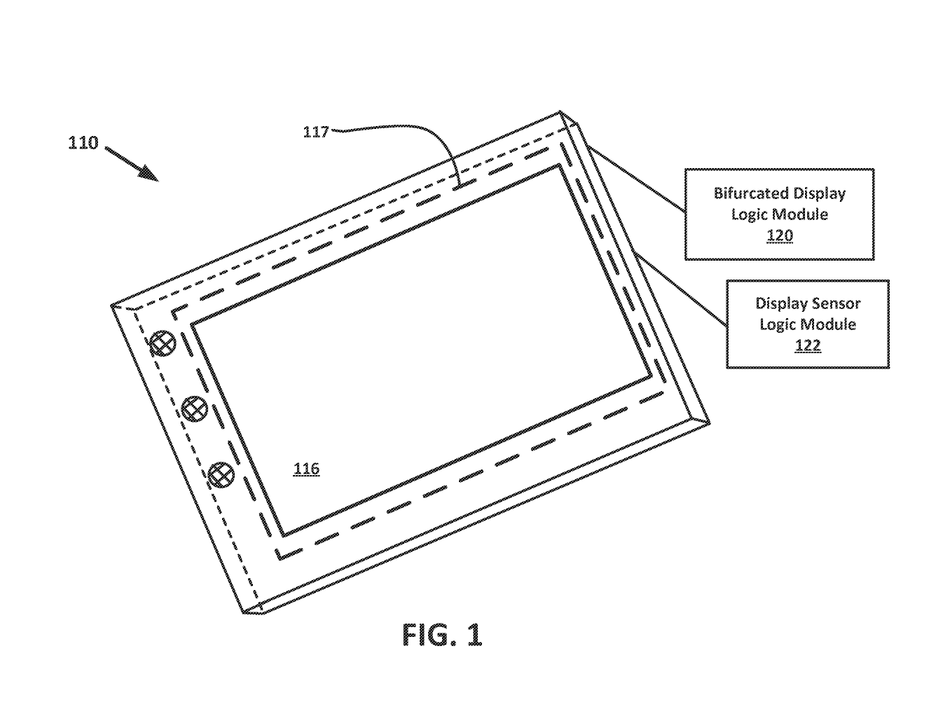

FIG. 1 illustrates an e-reading device 110, in one embodiment configured for operation of a primary display 116 and a secondary display 117. In the example of FIG. 1, e-reading device 110 comprises an electronic personal display device, shown by way of example as e-reading device 110. The terms e-reading device, computing device and electronic personal display device are used interchangeably herein.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reading device application that links the device to a network service and enables e-books provided through the service to be downloaded and stored, for consumption by way of e-reading. In another implementation, the e-reading device 110 can run a media playback or streaming application that receives files or streaming data from the network service. By way of example, the e-reading device 110 can be equipped with hardware and software to optimize certain application activities, such as reading electronic content (e.g., e-books). For example, the e-reading device 110 can have a tablet-like form factor, although variations are possible. In some cases, primary display 116 of e-reading device 110 may be a liquid crystal display and secondary display 117 may be an e-ink display or bi-stable e-ink display.

In additional detail, such a network service can include a content store server and a user account electronic library (e-library) storing e-books or digital content items. In some embodiments, the content store server and user account e-library may be implemented via server computing devices, as well as a server cloud computing system. The content store server may be an online store for purchasing of digital content items for download therefrom onto a resident memory of e-reading device 110 and/or the user account e-library which associates the e-reading device 110 with a user having an account. The user account can also be associated with ownership of, and/or accessibility to, one or more c-books and digital content items stored in content store server.

Yet further, the content store server and user account e-library can retain metadata associated with e-books or other digital content items that have been purchased or made available for consumption via a user's e-library. Thus, information relating to each of the e-books within a user account e-library can include a metadata set in addition to substantive digital text and image content portions. The metadata set can include, for example, information such as the graphic representation of the e-book, such as including artwork- or image-based representation of a counterpart physical paper book cover, as well as book content summary information, author information, title, short synapse or book review, publication date and language of the c-book, and book or volume series information.

Additionally, information typically rendered within precursor pages of paper books, such as an epigraph, a biographical page of the author, a table of contents, a book review, a book dedication, a foreword, author acknowledgements, an introduction, and a copyright notice may correspondingly be provided by, and accessible from, the metadata record unique to an e-book as electronically published. As used herein, the term precursor pages refers to the clustered pages of an e-book interposed between a displayed cover of the e-book and the actual substantive reading content within the e-book, providing information such as any or all of an epigraph, a biographical page of the author, a table of contents, a book review, a book dedication, a foreword, author acknowledgements, an introduction, and a copyright notice, and the like. The average e-book can typically feature a cluster of pages ranging from 3-15 precursor pages.

Further with reference to an example depiction of FIG. 1, one or both of displays 116, 117 may be touch-sensitive, to process touch inputs including gestures, e.g., a swipe gesture comprising a sustained touch while moving along a particular direction upon the touchscreen surface). For example, the display 116, and in some embodiments display 117, may be integrated with one or more touch sensors to provide a touch-sensing region on their respective display surfaces. For some embodiments, the one or more touch sensors may include capacitive sensors that can sense or detect a human body's capacitance as input. In the example of FIG. 1, the touch-sensing region coincides with a substantial surface area, if not all, of the display 116 respectively.

According to some embodiments, the e-reading device 110 includes display sensor logic module 122 to detect and interpret user input or user input commands made through interaction with the touch sensors of display 116, and in some cases display 117. By way of example, display sensor logic can detect a user making contact with the touch-sensing region of the display 116, otherwise referred to herein as a touch event. More specifically, display sensor logic can detect a touch event also referred to herein as a tap, an initial tap held in contact at display 116 for longer than some pre-defined threshold duration of time (otherwise known as a “long press” or a “long touch”), multiple taps performed either sequentially or generally simultaneously, swiping gesture actions made through user interaction with the touch sensing region of the display 116 or any combination of these gesture actions. Although referred to herein as a “touch” or a tap, it should be appreciated that in some design implementations, sufficient proximity to the screen surface, just short of actual physical contact, may register a “contact” or a “touch event”. Furthermore, display sensor logic can interpret such interactions in a variety of ways. For example, each such interaction may be interpreted as a particular type of user input associated with a respective input command, execution of which may trigger a change in state at display 116.

The touch screen display sensor capability may be applied by the user to transition through paginated content. The e-reading device 110 can display pages from e-books, and enable the user to transition from one page state to another, including advancing forward or backward within the pages of e-book content. In particular, an e-book can provide content that is rendered according to a sequence of digitally constructed pages, and the e-book can display page states in the form of single pages, multiple pages or portions thereof. In alternate embodiments, the e-book may be an e-magazine or an e-comic book, wherein each of the digitally constructed pages includes several distinctive panels or frames of text and/or images, and reading progression within a page may include navigating in sequential steps from one such panel or frame to another within a same page. Accordingly, a given page state can coincide with, for example, a single page, or two or more pages displayed at once, and in some implementations, the page transitioning feature may include single page transitions, chapter transitions, or cluster transitions (multiple pages at one time) within the sequence of digitally constructed pages comprising the e-book.

The term e-book as used herein is also intended to encompass an e-magazine or an c-comic book, wherein each of the digitally constructed pages includes several distinctive panels or frames of text and/or images, and reading progression within a page may include navigating in sequential steps from one such panel or frame to another within a same page.

Bifurcated display logic module 120 provides, in an embodiment, for activation and operation between displays 116, 117 of e-reading device 110. Bifurcated display logic module 120 includes logic providing, in part, to accomplish activation and operation of displays 116, 117 based on detecting, inferring, or being informed that a presentation of the e-book content on the e-reading device 110 to an audience is being performed.

Bifurcated display logic module 120 and display sensor logic module 122 can be implemented as software modules comprising instructions stored in a memory of a computing device such as the content store server and/or e-reading device 110. One or more embodiments of bifurcated display logic module 120 and display sensor logic module 122 described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of bifurcated display logic module 120 and display sensor logic module 122 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

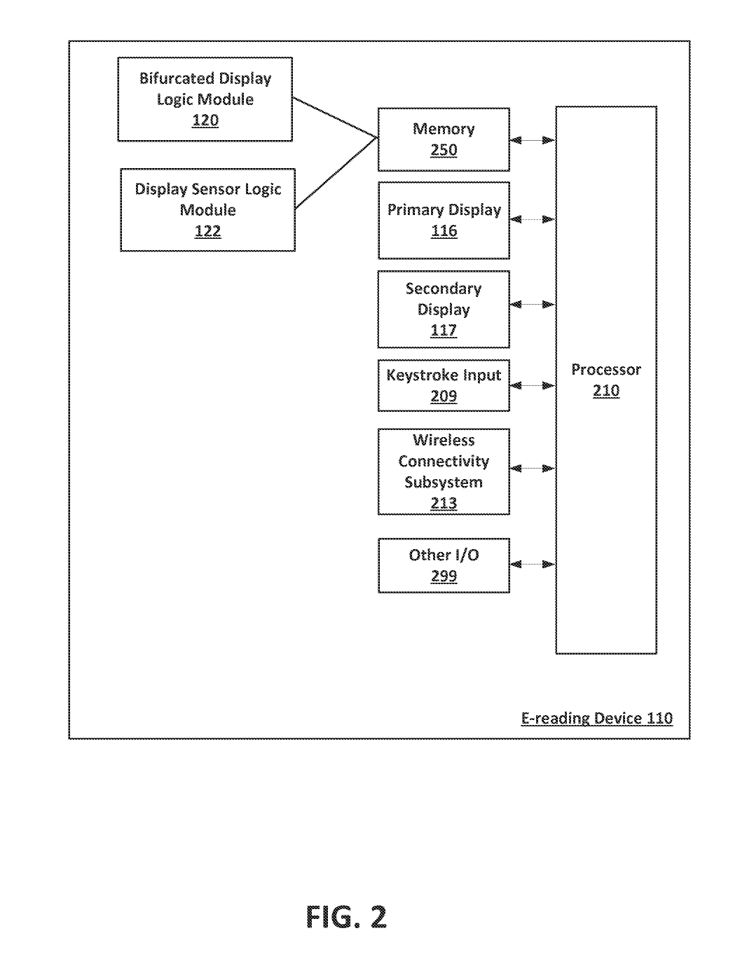

With reference now to FIG. 2, illustrated is a schematic architecture of a mobile computing device, such as a tablet or e-reading device, configured for bifurcated operation of dual displays 116, 117, according to an embodiment.

E-reading device 110 further includes processor 210, a memory 250 storing instructions and logic pertaining at least to display sensor logic, and bifurcated display logic module 120.

Processor 210 can implement functionality using the logic and instructions stored in memory 250. Additionally, in some implementations, processor 210 communicates with the network service. More specifically, the e-reading device 110 can access the network service to receive various kinds of resources, e.g., digital content items including e-books, digital videos, as well as configuration files and account information, as well as to provide information (e.g., user account information, service requests etc.). For example, e-reading device 110 can receive application resources, including digital content items such as e-books or media files that the user elects to purchase or otherwise download via the network service. The application resources, including e-books having content organized as a series of digitally constructed pages, that are downloaded onto the e-reading device 110 can be stored in memory 250.

In some implementations, primary display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components may be integrated with primary display 116. In other embodiments, the touch sensor components may be provided (e.g., as a layer) above or below primary display 116 such that individual touch sensor components track different regions of primary display 116.

Secondary display 117 can correspond to an electronic paper type display, such as an e-ink or bi-stable display that mimic conventional paper in the manner in which content is displayed. Typically, e-ink displays are more suited to e-reading under extreme ambient lighting conditions, such as very bright daylight or in near-darkness at bedtime, for long, immersive periods, resulting is less eye strain as compared to reading, for example, on an LCD display. Examples of such electronic paper display technologies include electrophoretic displays, electro-wetting displays, and electro-fluidic displays. Secondary display 117 can also be touch-sensitive; for example, in some embodiments, one or more of the touch sensor components may be integrated with secondary display 117, providing touch screen capability. Yet further, e-ink displays embodied in secondary display 117 consume relatively very minimal device battery power in comparison with, for example, an LCD display used in primary display 116. In some cases, e-ink displays consume computing device battery power at a less than 10 percent rate as compared to consumption of an LCD primary screen. For yet this additional reason, an e-ink screen as embodied in secondary display 117 would be very desirable for lengthy, immersive periods of reading e-book content via e-reading device 110.

Processor 210 can receive input from various sources, including touch sensor components at displays 116, 117, keystroke input 209 such as from a virtual or rendered keyboard, and other input mechanisms 299 (e.g., buttons, mouse, microphone, etc.). With reference to examples described herein, processor 210 can respond to input detected at the touch sensor components. In some embodiments, processor 210 responds to inputs from the touch sensor components in order to facilitate or enhance e-book activities such as generating e-book content on display 116, performing page transitions of the displayed e-book content, powering off e-reading device 110 and/or displays 116, 117, activating a screen saver, launching or closing an application, and/or otherwise altering a state of displays 116, 117.

In some embodiments, memory 250 may store display sensor logic that monitors for user interactions detected through the touch sensor components, and further processes the user interactions as a particular input or type of input. In an alternative embodiment, display sensor logic module may be integrated with the touch sensor components. For example, the touch sensor components can be provided as a modular component that includes integrated circuits or other hardware logic, and such resources can provide some or all of display sensor logic. In variations, some or all of display sensor logic may be implemented with processor 210 (which utilizes instructions stored in memory 250), or with an alternative processing resource.

Memory 250 also stores digital content items including e-books having respectively associated metadata records, each e-book having its unique metadata record in addition to the substantive content of the e-book, i.e., the digitally constructed paginated content for e-reading via the display of the e-reading device.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which e-reading device 110 is intended to operate, such as in accordance with Wi-Fi, Bluetooth, Near Field Communication (NFC) communication protocols, and the like.

Bifurcated display logic module 120 and display sensor logic module 122 can be implemented as a software module, comprising instructions stored in memory 250, on e-reading device 110. In one implementation, the local memory 250 can include records for each e-book in the user's e-library account. The user may have the content portion of select e-books archived remotely at a computer server cloud system, so as not to reside in the local memory 250, but be provided by the network service upon request or as needed.

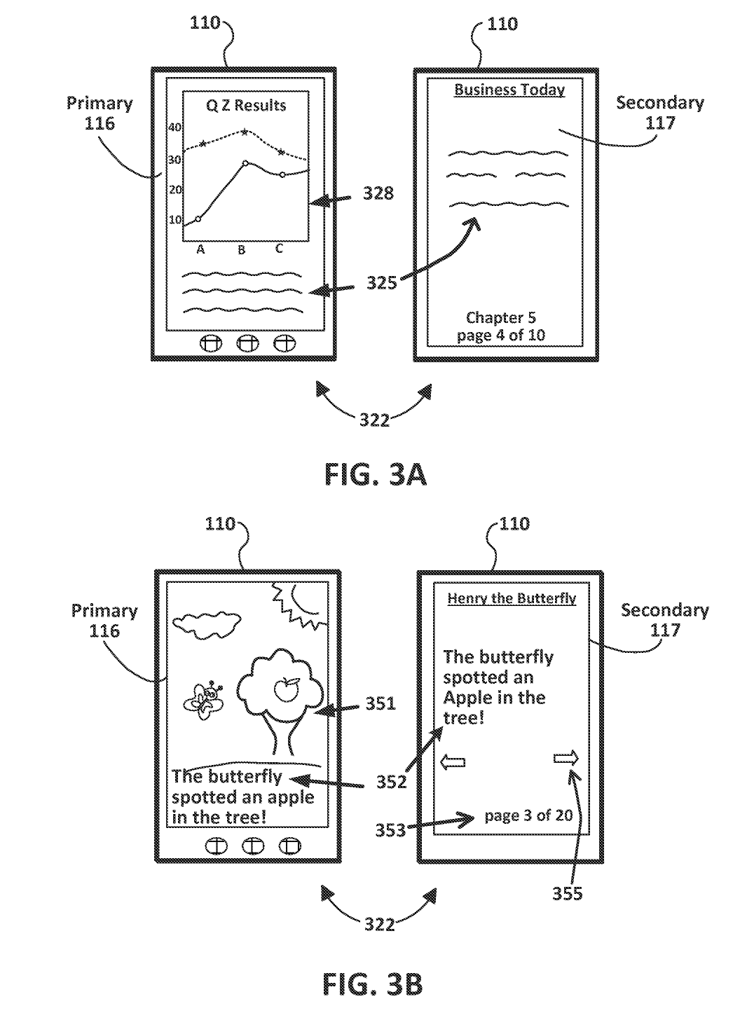

FIG. 3A illustrates a block diagram of an e-reading device 110 equipped with a primary display 116 on a first side and a secondary display 117 on an opposite side. Arrow 322 illustrates the flipping of the device from the primary display 116 to the reverse secondary display 117 side. In FIG. 3A, an e-book page including text portion such as text 325 and an image portion such as image 328, such as a graph, are displayed on the primary display 116. However, on secondary display 117 only the text 325 is displayed. Thus, a presenter can show an audience the primary display 116 that includes the entire e-book page of content and at the same time keep up with what the audience is viewing by looking at the text 325 that is provided on secondary display 117.

FIG. 3B illustrates a block diagram of another example of an e-reading device 110 equipped with a primary display 116 on a first side and a secondary display 117 on an opposite side. Again, arrow 322 illustrates the flipping of the device from the primary display 116 to the reverse secondary display 117 side. In FIG. 3B, an example of a page from a children's e-book is displayed on the primary display 116. In general, the page includes a picture 351 and text 352. However, in one embodiment, secondary display 117 shows text 352, a book location identifier 353 and navigation controls 355. Thus, a presenter can keep the primary display 116 facing the audience, such as a children's group, the entire time they are reading the e-book.

In one embodiment, primary display 116 can correspond to, for example, a liquid crystal display (LCD) or light emitting diode (LED) display that illuminates in order to provide content generated from processor 210. In some implementations, primary display 116 can be touch-sensitive. For example, in some embodiments, one or more of the touch sensor components may be integrated with primary display 116. In other embodiments, the touch sensor components may be provided (e.g., as a layer) above or below primary display 116 such that individual touch sensor components track different regions of primary display 116.

Secondary display 117 can correspond to an electronic paper type display, such as an e-ink or bi-stable display that mimic conventional paper in the manner in which content is displayed. Typically, e-ink displays are more suited to e-reading under extreme ambient lighting conditions, such as very bright daylight or in near-darkness at bedtime, for long, immersive periods, resulting is less eye strain as compared to reading, for example, on an LCD display. Examples of such electronic paper display technologies include electrophoretic displays, electro-wetting displays, and electro-fluidic displays. Secondary display 117 can also be touch-sensitive; for example, in some embodiments, one or more of the touch sensor components may be integrated with secondary display 117, providing touch screen capability. Yet further, e-ink displays embodied in secondary display 117 consume relatively very minimal device battery power in comparison with, for example, an LCD display used in primary display 116. In some cases, e-ink displays consume computing device battery power at a less than 10 percent rate as compared to consumption of an LCD primary screen. For yet this additional reason, an e-ink screen as embodied in secondary display 117 would be very desirable for lengthy, immersive periods of reading e-book content via e-reading device 110.

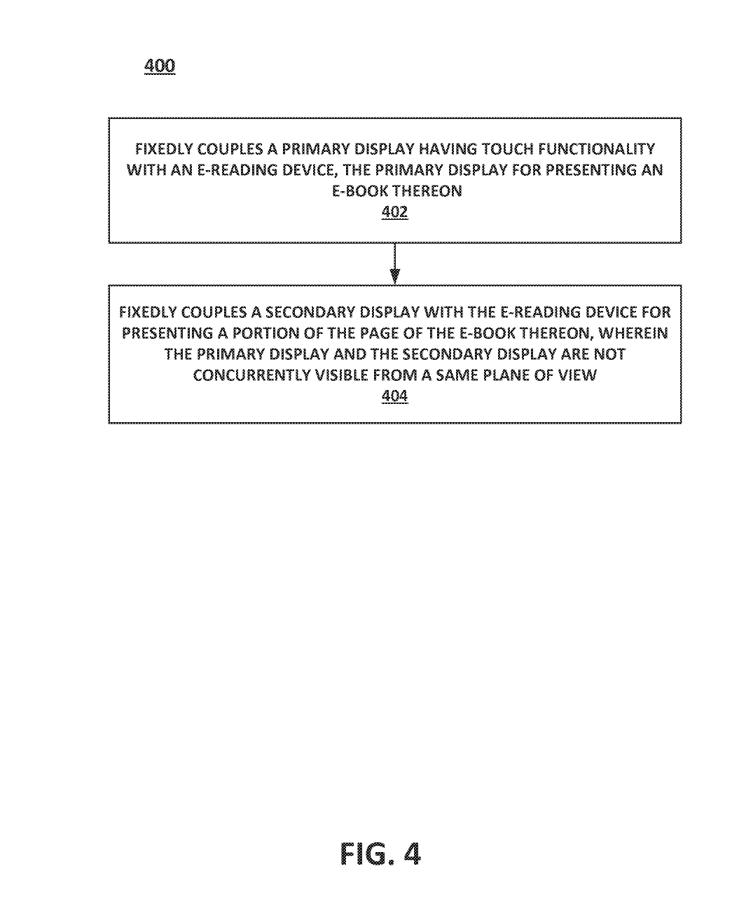

With reference to FIG. 4 a method 400 for bifurcated presentation of e-content on an e-reading device is shown in accordance with one embodiment.

Referring now to 402 of FIG. 4 and to FIGS. 3A and 3B, one embodiment fixedly couples a primary display 116 having touch functionality with an e-reading device 110, the primary display 116 for presenting a page of an e-book thereon. In one embodiment, primary display 116 is a liquid crystal display (LCD). In another embodiment, primary display 116 is a light emitting diode (LED) display.

With reference now to 404 of FIG. 4 and to FIGS. 3A and 3B, one embodiment fixedly couples a secondary display 117 with the e-reading device 110 for presenting a portion of the page of the e-book thereon, wherein the primary display 116 and the secondary display 117 are not concurrently visible from a same plane of view. In one embodiment, the secondary display 117 is a very-low power-usage display such as a bi-stable e-ink display. In one embodiment, the portion of the page of the e-book presented on the secondary display 117 includes a text portion, a book location identifier for the page of the e-book being presented; and an e-book navigator to provide a navigation capability through the e-book.

An example of the book location identifier 353 for the e-book being presented may include a page number, a chapter number, a percentage read, or the like. In one embodiment, by providing a book location identifier, the reader will be able to know their place in the e-book which will allow the reader to know when to pause for questions, stop the class, determine if they need to quicken or slow their reading pace, and the like.

In one embodiment, the e-book navigator is shown by navigation controls 355 of FIG. 3B. In general, by providing navigation controls 355 on secondary display 117, the reader can navigate through the pages of the e-book without having to refer to primary display 116. Moreover, since the navigation controls 355 are provided on secondary display 117, there will not be any controls interfering with the audience's presentation being delivered on primary display 116.

In one embodiment, a bifurcated or extracted portion of an e-book page of content is presented on the secondary display, which the presenter reads from, while full content is delivered via the primary display to the audience. That is, in one embodiment, the primary display is directed toward the audience and would include all visuals as coded in the CSS portion of the e-publication standard document, while the secondary display for the presenter would extract only words from the HTML text portion of the e-publication. In so doing, the audience sees both the illustrations and the text for any given page of a presentation or story while the reader will see only the text for that page on a battery-saving, low-energy display.

For example, as shown in FIG. 3A, primary display 116 shows both the text 325 and the image 328. In contrast, only the text 325 of the page is shown on the secondary display 117. Thus, whether presenting to coworkers, reading to children, lecturing on a subject that requires visuals referents, or the like; one embodiment enables a reader to show their audience the primary display 116, while still following along to a visually simplified version of the matching text on the secondary display 117 located on the rear surface of e-reading device 110.

In another example, such as leading an art history seminar to university students, a professor could see all the text extracted from an e-publication about the Mona Lisa on the secondary display, while the class would see both the text and the painting on the primary display. In yet another embodiment, the presenter could temporarily extract the text from an e-publication so that the presenter would see the words on their secondary display while the audience would only see the image(s).

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A system for bifurcated presentation of e-content on an e-reading device comprising:
a primary display of an e-reading device for presenting a page of an e-book thereon; and
a secondary display coupled with the e-reading device for presenting a portion of the page of the e-book thereon, wherein the primary display and the secondary display are not concurrently visible from a same plane of view.

2. The system of claim 1 wherein the primary display comprises a touch functionality.

3. The system of claim 1 wherein the secondary display is a lower power usage display than the primary display and does not have touch functionality.

4. The system of claim 1 wherein the primary display is fixedly coupled with a first side of the e-reading device and the secondary display is fixedly coupled with a second side of the e-reading device opposite of the primary display.

5. The system of claim 1 wherein the portion of the e-book presented on the secondary display is an HTML text portion of the page of the e-book.

6. The system of claim 1 wherein only an image portion and not a text portion of the page of the e-book is presented on the primary display.

7. The system of claim 1 wherein the secondary display comprises:
a book location identifier for the page of the e-book being presented; and
an e-book navigator to provide a navigation capability through the e-book.

8. A method for bifurcated presentation of e-content on an e-reading device, said method comprising:
fixedly coupling a primary display having touch functionality with an e-reading device, the primary display for presenting a page of an e-book thereon; and
fixedly coupling a secondary display with the e-reading device for presenting a portion of the page of the e-book thereon, wherein the primary display and the secondary display are not concurrently visible from a same plane of view.

9. The method of claim 8 wherein the secondary display comprises a touch functionality.

10. The method of claim 8 wherein the secondary display is a lower power usage display than the primary display and does not have touch functionality.

11. The method of claim 8 wherein the primary display is fixedly coupled with a first side of the e-reading device and the secondary display is fixedly coupled with a second side of the e-reading device opposite of the primary display.

12. The method of claim 8 wherein the portion of the e-book presented on the secondary display is an HTML text portion of the page of the e-book.

13. The method of claim 8 wherein only an image portion and not a text portion of the page of the e-book is presented on the primary display.

14. The method of claim 8 wherein the secondary display comprises:
a book location identifier for the page of the e-book being presented; and
an e-book navigator to provide a navigation capability through the e-book.

15. A system for bifurcated presentation of e-content on an e-reading device comprising:
a memory that stores a set of instructions;
a processor that access the set of instructions in the memory;
a primary display fixedly coupled with a first side of an e-reading device for presenting a page of an e-book thereon, the primary display having touch functionality; and
a secondary display fixedly coupled with a second side of the e-reading device opposite of the first side, the secondary display for presenting a portion of the page of the e-book thereon.

16. The system of claim 15 wherein the primary display comprises a liquid crystal display (LCD) screen.

17. The system of claim 15 wherein the primary display comprises a light emitting diode (LED) screen.

18. The system of claim 15 wherein the secondary display is a bi-stable e-ink display.

19. The system of claim 15 wherein the portion of the e-book presented on the secondary display is only a text portion of the page of the e-book.

20. The system of claim 15 wherein only an image portion and not a text portion of the page of the e-book is presented on the primary display.

21. The system of claim 15 wherein the secondary display comprises:
a book location identifier for the page of the e-book being presented; and
an e-book navigator to provide a navigation capability through the e-book.
